(19) United States
(12) Patent Application Publication
(10) Pub. No.: US 2019/0023965 A1
(43) Pub. Date: Jan. 24, 2019

(54) COMPOSITIONS AND METHODS FOR WELL CEMENTING

(71) Applicant: SCHLUMBERGER TECHNOLOGY CORPORATION, Sugar Land, TX (US)

(72) Inventors: Sébastien CATHELINE, Clamart (FR); Mickael ALLOUCHE, Clamart (FR); Emmanuel CANIVEZ, Clamart (FR)

(21) Appl. No.: 16/071,543

(22) PCT Filed: Jan. 20, 2016
(86) PCT No.: PCT/IB2016/000168

§ 371 Date: Jul. 20, 2018

(51) Int. Cl. C09K 8/467; C09K 8/42

(52) U.S. Cl. CPC C09K 8/467; C09K 2208/32; C09K 2208/08; C09K 8/424

(57) ABSTRACT

A method of cementing a subterranean well to form an expanded set cement acoustically coupled to the casing. Systems for cementing a wellbore are also disclosed.

### BACKGROUND

The statements in this section merely provide background information related to the present disclosure and may not constitute prior art.

The present disclosure broadly relates to systems and methods for cementing subterranean wells and maintaining zonal isolation therein.

Cementing of wellbores involves disposing a cement slurry between the well casing and the formation. As the slurry hardens or sets, the cement forms a barrier between the formation and the well casing thereby providing isolation between zones of the wellbore. Proper cement placement between the well casing and the formation is desired for a number of reasons, for example, to provide support for the casing, to prevent fluid from leaking to the surface, and for isolating producing zones from water-bearing zones, isolating production zones from other production zones, and the like.

Portland cement is specifically formulated to contract as it sets. Portland cement manufacturers generally limit the amount of certain alkaline impurities to avoid expansion of the expanded set cement, which in a number of end uses may result in the cement being unsound. In an unrestrained environment such as a road or building, expansion of the expanded set cement can result in cracking and failure. Contracting of cement, however, reduces contact of the cement with the well casing as the cement sets into a hardened mass. This contraction may form a micro annulus, i.e., an airspace, between the well casing and the hardened cement, which destroys acoustic coupling between the two.

In well cementing operations, contamination on the outer surface of the casing may also prevent contact or bonding of the cement with the casing. Under circumstances in which various contaminants are present on the outer side of the casing, a small gap may form between the casing and hardened cement. This may be a twofold effect. Firstly, the effect may result from an increase of the space between the well casing and the cement (in addition to the space occupied by the contaminant) resultant from the contracting of the cement as it sets. Secondly, the gap may result from a lack of physical bonding between the cement and the well casing. The result is the formation of a micro annulus between the set cement and the casing, the set cement and the formation interface, or both, which destroys the acoustic coupling required to determine the soundness of the cemented wellbore.

To ensure zone isolation, the quality and placement of cement between the formation and the casing is determined by acoustic logging in which sonic or ultrasonic imagers known in the art are commonly used. Acoustic logs, however, do not measure cement quality directly, rather, this value is inferred from the degree of acoustic coupling of the cement to the casing and to the formation. When properly acquired and interpreted, cement-bond logs (CBL) provide highly reliable estimates of well integrity and zone isolation. However, acoustic logging relies on acoustic coupling between the cement and the casing, the cement and the formation, or both. Acoustic coupling is the ability of sound waves (energy) to travel between the casing and the cement, the cement and the formation, or both. Poor acoustic coupling between the cement and the casing, such as when there is a lack of contact between the cement and the casing due to the presence of a micro annulus between the two, renders these acoustic tools unable to adequately characterize the quality of the cement sheath disposed between the casing and the formation.

A common practice in the art is to acquire the CBL while applying pressure inside the casing in an amount sufficient to expand the casing and thus, ensure acoustic coupling between the cement sheath and the casing. However, expanding of the casing may potentially result in reducing the soundness of the cement, which may actually induce the presence of a micro annulus or otherwise reduce the bonding between the casing and the cement resulting in inadequate zonal isolation.

Various chemical solutions have been employed to ensure that the casing is clean and water-wet when the cement comes in contact with the casing to improve the bonding of the cement thereto. However, such attempts have not extinguished the long felt need in the art for improved acoustic coupling between the outer surface of the casing and the cement placed in the borehole. In particular, when the outer surface of the casing contains various contaminants, which inhibit bonding of the cement to the casing.

### SUMMARY

The present disclosure is directed to cement slurries and methods of cementing a subterranean well having a borehole with improved acoustic coupling between the cement and the casing.

In embodiments, a cement slurry for cementing a subterranean well between a casing disposed within a borehole and a formation comprises a hydraulic cement, water, and an amount of an expanding agent suitable to produce from 0.1 percent to 3 percent expansion of the cement slurry upon hardening into an expanded set cement as determined according to API 10B-5 or an equivalent thereof.

In embodiments, a system for cementing a subterranean well in an annulus between a casing disposed within a borehole and a formation, comprises a cement slurry stage comprising a hydraulic cement, water, and an amount of an expanding agent suitable to produce from 0.1 percent to 3 percent expansion of the cement slurry upon hardening into an expanded set cement as determined according to API 10B-5; and a pumping system to place a stage of the slurry in the annulus.

In embodiments, a method of cementing a subterranean well having a borehole comprise: preparing a cement slurry comprising water, hydraulic cement, and an amount of an expanding agent suitable to produce from 0.1 percent to 3 percent expansion of the cement slurry upon hardening into an expanded set cement as determined according to API 10B-5 or an equivalent thereof;
(ii) disposing the slurry between a formation and a casing in a downhole region of the well borehole; and
(iii) allowing the slurry to harden and expand in an amount sufficient to form an expanded set cement acoustically coupled to the casing.

### BRIEF DESCRIPTION OF THE DRAWINGS

FIG. 1 shows a graphical representation of an acoustic log of a cemented wellbore after 5 days set time with a comparative non-expanding cement; and

FIG. 2 shows a graphical representation of an acoustic log of a cemented wellbore after 5 days set time with an expanding cement according to embodiments disclosed herein.

### DETAILED DESCRIPTION

The present disclosure will be described in terms of treatment of vertical wells, but is equally applicable to wells of any orientation. The disclosure is described in terms indicative of hydrocarbon-production wells, but it is to be understood that the disclosure is equally directed to wells for the production of other fluids, such as water, carbon dioxide, for injection, or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the Applicants appreciate and understand that any and all data points within the range are to be considered to have been specified, and that the Applicants have possession of the entire range and all points within the range.

As used in the specification and claims, “near” is inclusive of “at.” The term “and/or” refers to both the inclusive “and” case and the exclusive “or” case, whereas the term “and or” refers to the inclusive “and” case only and such terms are used herein for brevity. For example, a component comprising “A and/or B” may comprise A alone, B alone, or both A and B; and a component comprising “A and or B” may comprise A alone, or both A and B.

As used herein, a cement refers to a concrete mixture, which sets and hardens to bind materials together. A hydraulic cement e.g., Portland cement, sets and become adhesive due to chemical reactions between the dry ingredients and water. A hydraulic cement is characterized by the ability to set in wet condition or even under water. In general, Portland cement refers a mixture of oxides of calcium, silicon, and aluminum produced by heating limestone with clay thereby sintering the mixture to fuse the components together without melting to the point of liquefaction. This sintering process forms “clinker” which is then ground and combined with a source of sulfate. Suitable sources of sulfate include gypsum or others known in the art. cf., British Patent 5022GB, Oct. 21, 1874 “An Improvement in the Mode of Producing an Artificial Stone”.

As used herein, a cement slurry refers to a mixture comprising water and cement. A cement slurry may further include aggregate, various modifiers, additives, and the like.

Acoustic coupling between two materials refers to the ability of energy to pass between the materials. In particular, the quality of the contact between two materials which allows sound wave energy to travel between the two materials. A cement bond log (CBL), also referred to herein as an acoustic log or well-log, refers to a measurement acquired by a sonic “tool” placed in the wellbore for evaluating the mechanical integrity and quality of the cement placement and characteristics in a cemented well, thereby providing information about well integrity and zone isolation.

Acoustic logs may be determined using one or more tools known in the art. In general, an acoustic or well-log tool comprises one or more monopole (axisymmetric) transmitters with two or more receivers. Sonic tools operate on the principle that acoustic amplitude is rapidly attenuated in a “good” cement bond, but not in partial bond or free pipe. These measurements may include compressional-wave travel time (transit time), amplitude (first pipe arrival), attenuation per unit distance, or a combination thereof, as readily understood by one of skill in the art. Suitable acoustic or cement bond logs may include omnidirectional measurements, azimuthally sensitive measurements for channel evaluation, and the like.

As used herein, an expanding agent refers to a material added to a cement slurry, which sets or hardens to form an expanded or expansive set cement. As used herein, an expanded set cement is a cement comprising an expanding agent that has sets to form a harden mass having an increased volume relative to a similar set cement (e.g., Portland cement) treated under the same conditions in the same way, but which does not include the expanding agent.

For purposes herein, the percent expansion of the cement slurry upon hardening into an expanded set cement is determined according to API 10B-5, or an equivalent thereof. Likewise, for purposes herein, an expanded set cement is consistent with the definition provided by ACI 223-98, or an equivalent thereof.

As used herein, a cemented wellbore refers to a wellbore in which a cement slurry has been disposed between the formation and the casing in a downhole region of the well borehole and allowed to set. Likewise, cementing a wellbore or a cementing job refers to the process in which a cement slurry is disposed between the formation and the casing in a downhole region of the well borehole and allowed to set. For purposes herein, the cement slurry may be disposed into the wellbore by any means known in the art.

As used herein, a wellbore casing refers to the pipe or pipes disposed within a wellbore. The outer surface of the casing refers to the side of casing closest to the formation, while the inner surface of the casing refers to the side of the casing located opposite the outer side through the thickness of the casing itself.

In embodiments, a system for cementing a subterranean well in an annulus between a casing disposed within a borehole and a formation, comprises a cement slurry stage comprising hydraulic cement, water, and an amount of an expanding agent suitable to produce from 0.1 percent to 3 percent expansion of the cement slurry upon hardening into an expanded set cement as determined according to API 10B-5 or an equivalent thereof.

In embodiments, the amount of the expanding agent present in the cement slurry is suitable to produce from 0.5 percent to 2 percent expansion of the cement slurry upon hardening into the expanded set cement as determined according to API 10B-5 or an equivalent thereof.

In embodiments, the amount of the expanding agent present in the cement slurry is suitable to produce an amount of expansion of the cement slurry upon hardening into the expanded set cement suitable to remove at least a portion of a material from a surface of the well casing e.g., by squeezing and displacing the material from a surface of the casing, such that the expanded set cement is in direct physical contact with, and acoustically coupled to the casing.

In embodiments, the amount of the expanding agent present in the cement slurry is suitable to produce an amount of expansion of the cement slurry upon hardening into the expanded set cement suitable to compress at least a portion of a material present on a surface of the casing between the expanded set cement and the casing such that the expanded set cement is acoustically coupled to the casing.

In some embodiments, the system further comprises an oil-based fluid for circulation in the annulus to deposit the material on the casing surface, and an interface between the oil-based fluid and the cement slurry stage for displacement of the oil-based fluid by the cement slurry stage during the placement of the cement slurry stage and the annulus.

In some embodiments, the system further comprises an oil-based fluid for circulation in the annulus to deposit the material on the casing surface, and optionally a spacer stage between the oil-based fluid and the cement slurry stage. In embodiments, the amount of the expanding agent present in the cement slurry is suitable to produce an amount of expansion of the cement slurry upon hardening into the expanded set cement suitable to form the expanded set cement, which is acoustically coupled to the casing and to at least a portion of the formation.

In embodiments, the amount of the expanding agent present in the cement slurry is suitable to produce an amount of expansion of the cement slurry upon hardening into the expanded set cement suitable to form the expanded set cement having a Young's modulus from about 1 to about 10 GPa as determined by ASTM C469 or an equivalent thereof.

In embodiments, the expanding agent is present in the cement slurry from about 0.1 percent by weight of hydraulic cement to about 20 percent by weight of hydraulic cement.

In embodiments, the expanding agent comprises CaO, MgO, or a combination thereof.

In embodiments, the cement further comprises an accelerator, a retarder, an air entraining agent, a defoamer, a plasticizer, a pigment, a corrosion inhibitor, fly ash, ground granulated blast furnace slag, silica fume, high reactivity metakaolin, inorganic fibers, organic fibers, carbon nanofibers, or a combination thereof.

In embodiments, a method of cementing a subterranean well having a casing disposed within a borehole, comprises preparing a cement slurry comprising water, a hydraulic cement, and an amount of an expanding agent suitable to produce from 0.1 percent to 3 percent expansion of the cement slurry upon hardening into an expanded set cement as determined according to API 10B-5 or an equivalent thereof, disposing the slurry between a formation and the casing in a downhole region of the well borehole; and allowing the cement slurry to harden and expand in an amount sufficient to form an expanded set cement acoustically coupled to the casing.

In some embodiments of the method, the amount of the expanding agent present in the cement slurry is suitable to produce an amount of expansion of the cement slurry upon hardening into the expanded set cement to compress at least a portion of a material present on a surface of the casing between the expanded set cement and the casing to acoustically couple the expanded set cement to the casing.

In some embodiments, the method further comprises circulating an oil-based fluid, an aqueous fluid, or both, through the annulus to deposit the material on the surface of the casing, and displacing the fluid from the annulus with the slurry.

In some embodiments, the method further comprises circulating an oil-based fluid, an aqueous fluid, or both, through the annulus to deposit the material on the surface of the casing, and displacing a portion of the fluid from the annulus with a spacer stage pumped ahead of the slurry.

Contamination of the casing by fluids such as formation fluid, drilling mud or spacer prior to the cement job is a common occurrence in field operation. It has always been an issue for the evaluation of the cement job with acoustic tools as it leads to a lack of acoustic coupling between the cement and the casing.

Acoustic cement evaluation tools are increasingly sensitive to the acoustic coupling of the cement to the casing interface. Variations in acoustic coupling may lead to incorrect assessments of the cement placement and quality of the cementing of the wellbore, and may also result in a lack of zonal isolation.

It has been discovered that use of a properly selected expanding cement results in a cemented wellbore having improved acoustic coupling between the casing and the cement. The restrained expansion resultant from the limited space between the formation and the casing in the borehole has been found to impose a compressive stress at the casing/cement interface leading to a significant improvement of the acoustic coupling, even when a mud layer or other source of contamination is present between the cement and the casing, i.e., contamination on the surface of the casing closest in proximity to the formation, referred to herein as the outer surface of the casing.

Well cementing is important in achieving zonal isolation. To form an impermeable barrier, cement should fill the entire annular space between the casing and the formation.

Prior to cementing operations for the construction of a well, the casings that are to be cemented are exposed to several different fluids such as drilling mud, spacer fluids, and formation fluids. These fluids can be difficult to remove before the cementation, especially when they are oil-based leading to a poor bonding and thus poor acoustic coupling between the cement and the casing. Tailoring the expansion properties of the cement slurry results in forming an expanded cement sheath with improved acoustic coupling to the casing. While not wishing to be bound by theory, it is believed that in embodiments, the expansion of the cement may displace at least a portion of the mud layer or other contaminants away from the outer surface of the casing such that the contaminants are dispersed, contained, or both, within the set cement. The expansion may thus result in a clean surface to which the cement bonds with improved acoustic coupling. Another possible explanation of the improvement includes the belief that as the cement slurry sets, the bulk expansion of the hardening cement traps and squeezes the contaminants against the casing, resulting in a compressive radial stress between the casing and the cement, which provides the observed improvement in acoustic coupling between the casing and the cement. Another possible explanation of the improvement in acoustic coupling observed according to embodiments disclosed herein includes the expanding cement displacing at least a portion of the contaminants from the outer surface of the casing, Accordingly, it

It is further believed that the expansion of the hardening cement may compress the contaminants between the cement and the casing, eliminating the formation of a micro annulus, leading to a cemented wellbore having improved acoustic coupling between the cement and the casing, the cement and the formation, or both. In addition, the improved acoustic coupling also results in improved zonal isolation in the wellbore over methods known in the art.

In some embodiments, where an oil-based fluid is circulated in the annulus to deposit the material on the casing surface, and where the acoustic coupling can be obtained according to embodiments disclosed herein despite the presence of the material on the casing surface, the placement of the cement slurry in the annulus, in embodiments, may be facilitated by eliminating the spacer stage that is normally used ahead of a cementing slurry stage since embodiments disclosed herein may render this step unnecessary, since the surface of the casing need not be clean of the material to effect acoustic coupling. In alternative embodiments, the volume of the spacer stage can be relatively smaller than normal, e.g., less than the volume of the cement slurry stage, or less than half the volume of the cement slurry stage, or where a volume ratio of the spacer stage to the cement slurry stage is from 1:200 up to less than 1:3, or less than 1:10, or less than 1:20, or less than 1:50 in view of the improved acoustic coupling achieved by embodiments disclosed herein.

In embodiments, a cement slurry for cementing a subterranean well between a casing disposed within a borehole and a formation comprises a hydraulic cement, water, and an amount of an expanding agent suitable to produce from 0.1 percent to 3 percent expansion of the cement slurry upon hardening into an expanded set cement as determined according to API 10B-5 or an equivalent thereof.

Hydraulic cement suitable for use herein include any cement which hardens in the presence of water or underwater. In embodiments, the hydraulic cement comprises Portland cement.

In embodiments, the cement slurry may further comprise an accelerator, a retarder, an air entraining agent, a defoamer, a plasticizer, a pigment, a corrosion inhibitor, fly ash, ground granulated blast furnace slag, silica fume, high reactivity metakaolin, inorganic fibers, organic fibers, carbon nanofibers, or a combination thereof. One or more of these additives may be included in the cement slurry to further tailor the expansion of the cement upon forming the expanded set cement, as well as other properties including Young's modulus.

Suitable accelerators, which are added to speed up the hydration (hardening) of the concrete include CaCl₂, Ca(NO₃)₂ and NaNO₃. Retarders, which slow the hydration of concrete may also be employed. Suitable retarders include polyol retarders such as various sugars, e.g., sucrose, as well as sodium gluconate, glucose, citric acid, tartaric acid, and the like.

In embodiments, the cement slurry may comprise from about 0.1 to about 20 percent by weight of cement of suitable air entraining agents, which may be added to the cement slurry to tailor the expansion or the Young's modulus of the expanded set concrete. In alternative embodiments, the cement slurry may comprise from about 0.1 to about 20 percent by weight of cement of suitable defoamers, which may be used to remove air from the slurry thereby tailoring the expansion or the Young's modulus of the expanded set concrete to improve acoustic coupling between the expanded set cement and the casing. In embodiments, the cement slurry may comprise from about 1 to about 20 percent by weight of cement of a suitable plasticizer added according to embodiments disclosed herein thereby tailoring the expansion or the Young's modulus of the expanded set concrete to improve acoustic coupling between the expanded set cement and the casing. Suitable plasticizers include lignosulfonate, sulfonated naphthalene formaldehyde condensate, sulfonated melamine formaldehyde condensate, acetone formaldehyde condensate, polycarboxylate ethers, and the like.

In embodiments, pigments may be included as an indication of the material to field personnel or for product identification. Pigments may also be added to assist in tailoring of the expansion of the cement slurry by color matching of the slurry with a predetermined color scheme. In embodiments, corrosion inhibitors may be used to minimize the corrosion of steel and other metals present in the wellbore. In embodiments, various bonding agents known in the art may be employed as may be pumping aids and the like, as known in the art.

In embodiments, the cement slurry may comprise high reactivity metakaolin, which may supplant from 0.1 to 25 wt % of the Portland cement to improve the engineering properties of the cement. In embodiments, the cement slurry may comprise from about 1 to about 20 percent by weight of cement of various inorganic, fibers, organic fibers, carbon nanofibers, or the like, which may be added to further constrain expansion of the cement upon hardening, to affect the Young's modulus, or a combination thereof, thereby improving the acoustic coupling between the expanded set cement and the casing.

In embodiments, the amount of the expanding agent present in the cement slurry is suitable to produce equal to or greater than about 0.1 percent, or equal to or greater than about 0.5 percent, or equal to or greater than about 0.7 percent, or equal to or greater than about 1 percent expansion, or equal to or greater than about 1.5 percent expansion, or equal to or greater than about 2 percent expansion, and less than or equal to about 3 percent expansion, or less than or equal to about 2.5 percent expansion, or less than or equal to about 2 percent expansion, as determined according to API 10B-5 or an equivalent thereof.

In embodiments, the expanded set cement may be more flexible than the formation, the casing, or both to allow for adequate expansion and compressibility of the cement between the formation and the casing, thereby improving the acoustic coupling between the expanded set cement and the casing. The flexibility of the cement is largely determined by the water to cement ratio used to form the slurry. However, the amount of expanding agent added to the slurry, along with other additives may also have an effect. In embodiments, the water to cement ratio may be adjusted along with the amount of the expanding agent and other additives present in the cement slurry to produce the expanded set cement having a Young's Modulus equal to or greater than about 1 GPa, or equal to or greater than about 2 GPa, or equal to or greater than about 3 GPa, or equal to or greater than about 4 GPa, or equal to or greater than about 5 GPa, and less than or equal to about 7 GPa, or less than or equal to about 10 GPa, as determined by ASTM C469 or an equivalent thereof.

In embodiments, the expanding agent is present in the cement slurry equal to or greater than about 0.1 percent by weight of hydraulic cement, or equal or greater than to about 1 percent by weight of hydraulic cement, or equal to or greater than about 3 percent by weight of hydraulic cement, or equal to or greater than about 5 percent by weight of hydraulic cement, and less than or equal to about 20 percent by weight of hydraulic cement.

Any expanding agent which results in expansion of the slurry upon hardening into the expanded set concrete may be employed. In embodiments, suitable expanding agents for use herein include CaO, MgO, or a combination thereof. Expanding agents are typically produced by grinding, pulverizing, or otherwise mastication of clinker produced using particular conditions known in the art. In embodiments, the expanding agent may be obtained by heat treatment of clinker or pulverized clinker containing free lime, a hydraulic compound and calcium sulfate anhydrite in a carbon dioxide gas atmosphere to form 0.5 to 10 percent by mass calcium carbonate therein, as disclosed in U.S. Pat. No. 8,663,383, the entire contents of which are incorporated by reference herein. In other embodiments, the expanding agent contains calcium sulfoaluminate cements produced from clinkers that include Klein's compound, the calcium sulfoaluminate generally represented by the formula Ca₄(AlO₂)₆SO_{4 ,} represented as C₄A₃S in Cement chemist's notation. Other suitable expanding agents include those disclosed in U.S. Pat. No. 3,884,710, U.S. Pat. No. 3,947,288, U.S. Pat. No. 4,205,994, and U.S. Pat. No. 5,846,316, the entire contents of which are incorporated by reference herein.

### EMBODIMENTS LISTING

Accordingly, the present disclosure provides the following embodiments, among others:
C1 A cement slurry for cementing a subterranean well between a casing disposed within a borehole and a formation, comprising: a hydraulic cement, water, and an amount of an expanding agent suitable to produce from 0.1 percent to 3 percent expansion of the cement slurry upon hardening into an expanded set cement as determined according to API 10B-5 or an equivalent thereof.
C2 The cement slurry according to embodiment C1, wherein the amount of the expanding agent present in the cement slurry is suitable to produce from 0.5 percent to 2 percent expansion of the cement slurry upon hardening into the expanded set cement as determined according to API 10B-5 or an equivalent thereof.
C3 The cement slurry according to embodiment C1 or C2, wherein the amount of the expanding agent present in the cement slurry is suitable to produce an amount of expansion of the cement slurry upon hardening into the expanded set cement suitable to displace at least a portion of a material from a surface of the casing such that the expanded set cement is bonded compression with, and acoustically coupled to the casing.
C4 The cement slurry according to any one of embodiments C1-C3, wherein the amount of the expanding agent present in the cement slurry is suitable to produce an amount of expansion of the cement slurry upon hardening into the expanded set cement suitable to compress at least a portion of a material present on a surface of the casing between the expanded set cement and the casing such that the expanded set cement is acoustically coupled to the casing.
C5 The cement slurry according to any one of embodiments C1-C4, wherein the amount of the expanding agent present in the cement slurry is suitable to produce an amount of expansion of the cement slurry upon hardening into the expanded set cement suitable to form the expanded set cement which is acoustically coupled to the casing and to at least a portion of the formation.
C6 The cement slurry according to any one of embodiments C1-C5, wherein the cement slurry is suitable to produce the expanded set cement having a Young's modulus from about 1 to about 10 GPa, as determined by ASTM C469 or an equivalent thereof.
C7 The cement slurry according to any one of embodiments C1-C6, wherein the expanding agent is present in the cement slurry from about 0.1 percent by weight of hydraulic cement to about 20 percent by weight of hydraulic cement.
C8 The cement slurry according to any one of embodiments C1-C7, wherein the expanding agent comprises CaO, MgO, or a combination thereof.
C9 The cement slurry according to any one of embodiments C1-C8 further comprising an accelerator, a retarder, an air entraining agent, a defoamer, a plasticizer, a pigment, a corrosion inhibitor, fly ash, ground granulated blast furnace slag, silica fume, high reactivity metakaolin, inorganic fibers, organic fibers, carbon nanofibers, or a combination thereof.
M1 A method of cementing a subterranean well having a casing disposed within a borehole, comprising:
   (i) preparing a cement slurry according to any one of embodiments C1-C9,
   (ii) disposing the slurry in an annulus between a formation and the casing in a downhole region of the well borehole; and
   (iii) allowing the cement slurry to harden and expand in an amount sufficient to form an expanded set cement acoustically coupled to the casing.
M2 A method of cementing a subterranean well having a casing disposed within a borehole, comprising:
   (i) preparing a cement slurry comprising water, hydraulic cement, and an amount of an expanding agent suitable to produce from 0.1 percent to 3 percent expansion of the cement slurry upon hardening into an expanded set cement as determined according to API 10B-5;
   (ii) disposing the slurry in an annulus between a formation and the casing in a downhole region of the well borehole; and
   (iii) allowing the cement slurry to harden and expand in an amount sufficient to form an expanded set cement acoustically coupled to the casing.
M3 The method according to embodiment M2, wherein the expanded set cement has a Young's modulus from about 1 to about 10 GPa, as determined by ASTM C469.
M4 The method according to embodiment M2 or M3, wherein the amount of the expanding agent present in the cement slurry is suitable to produce from 0.5 percent to 2 percent expansion of the cement slurry upon hardening into the expanded set cement.
M5 The method according to any one of embodiments M2 through M4, wherein the amount of the expanding agent present in the cement slurry is suitable to produce an amount of expansion of the cement slurry upon hardening into the expanded set cement suitable to compress at least a portion of a material present on a surface of the casing between the expanded set cement and the casing such that the expanded set cement is acoustically coupled to the casing.
M6 The method according to any one of embodiments M1 through M4, further comprising circulating an oil-based fluid through the annulus to deposit the material on the surface of the casing, and displacing the oil-based fluid from the annulus with the cement slurry.
M7 The method according to any one of embodiments M1 through M6, further comprising circulating an oil-based fluid through the annulus to deposit the material on the surface of the casing, and displacing a portion of the oil-based fluid from the annulus with a spacer stage pumped ahead of the cement slurry.
M8 The method according to any one of embodiments M2 through M7, wherein the amount of the expanding agent present in the cement slurry is suitable to produce an amount of expansion of the cement slurry upon hardening into the expanded set cement suitable to form the expanded set cement which is acoustically coupled to the casing and to at least a portion of the formation.
M9 The method according to any one of embodiments M2 through M8, wherein the expanding agent is present in the cement slurry from about 0.1 percent by weight of hydraulic cement to about 20 percent by weight of hydraulic cement.
M10 The method according to any one of embodiments M2 through M9, wherein the expanding agent comprises CaO, MgO, or a combination thereof.
M11 The method according to any one of embodiments M2 through M10, wherein the cement further comprises an accelerator, a retarder, an air entraining agent, a defoamer, a plasticizer, a pigment, a corrosion inhibitor, fly ash, ground granulated blast furnace slag, silica fume, high reactivity metakaolin, inorganic fibers, organic fibers, carbon or a combination thereof.
M12 A method of cementing a subterranean well having a material disposed on an outer surface of a casing disposed within a borehole, comprising:
   (i) preparing a cement slurry comprising water, hydraulic cement, and an amount of an expanding agent suitable to produce expansion of the cement slurry upon hardening into an expanded set cement as determined according to API 10B-5;
   (ii) disposing the slurry in an annulus between a formation and the outer surface of the casing in a downhole region of the well borehole; and
   (iii) allowing the cement slurry to harden and expand in an amount sufficient to form an expanded set cement having a Young's modulus from about 1 to about 10 GPa, as determined by ASTM C469, which is acoustically coupled to the casing and to at least a portion of the formation;
   the expanding agent comprising CaO, MgO, or a combination thereof; and the amount of expanding agent present in the cement slurry being suitable to produce an amount of expansion of the cement slurry upon hardening into the expanded set cement which compresses at least a portion of a material present on the outer surface of the casing between the expanded set cement and the casing.
S1 A system for cementing a subterranean well in an annulus between a casing disposed within a borehole and a formation, comprising: a cement slurry stage comprising the cement slurry according to any one of embodiments C1-C9; and a pumping system to place a stage of the slurry in the annulus.
S2 A system for cementing a subterranean well in an annulus between a casing disposed within a borehole and a formation, comprising: a cement slurry stage comprising a hydraulic cement, water, and an amount of an expanding agent suitable to produce from 0.1 percent to 3 percent expansion of the cement slurry upon hardening into an expanded set cement as determined according to API 10B-5; and a pumping system to place a stage of the slurry in the annulus.
S3 The system according to embodiment S2, wherein the expanded set cement has a Young's Modulus from about 1 to about 10 GPa, as determined by ASTM C469.
S4 The system according to embodiment S2 or S3, wherein the amount of the expanding agent present in the cement slurry is suitable to produce an amount of expansion of the cement slurry upon hardening into the expanded set cement that the expanded set cement is acoustically coupled to the casing.
S5 The system according to any one of embodiments S2 through S4, wherein the amount of the expanding agent present in the cement slurry is suitable to produce an amount of expansion of the cement slurry upon hardening into the expanded set cement suitable to form the expanded set cement which is acoustically coupled to at least a portion of the formation.
S6 The system according to any one of embodiments S1 through S5, further comprising a material deposited on a surface of the casing, and wherein at least a portion of a material present on a surface of the casing is compressed between the expanded set cement and the casing such that the expanded set cement is acoustically coupled to the casing.
S7 The system according to any one of embodiments S1 through S6, further comprising an oil-based fluid for circulation in the annulus to deposit the material on the casing surface, and optionally a spacer stage for circulation in the annulus between the oil-based fluid and the cement slurry stage.
S8 The system according to any one of embodiments S2 through S7, wherein the expanding agent is present in the cement slurry from about 0.1 percent by weight of hydraulic cement to about 20 percent by weight of hydraulic cement.
S9 The system according to any one of embodiments S2 through S8, wherein the expanding agent comprises CaO, MgO, or a combination thereof.
S10 The system according to any one of embodiments S2 through S9, wherein the cement further comprises an accelerator, a retarder, an air entraining agent, a defoamer, a plasticizer, a pigment, a corrosion inhibitor, fly ash, ground granulated blast furnace slag, silica fume, high reactivity metakaolin, inorganic fibers, organic fibers, carbon nanofibers, or a combination thereof.
E1. A method of cementing a subterranean well having a casing disposed within a borehole, comprising:
   (i) preparing a cement slurry comprising water, hydraulic cement, and an amount of an expanding agent suitable to produce from 0.1 percent to 3 percent expansion of the cement slurry upon hardening into an expanded set cement as determined according to API 10B-5;
   (ii) disposing the slurry between a formation and the casing in a downhole region of the well borehole; and
   (iii) allowing the cement slurry to harden and expand in an amount sufficient to form an expanded set cement acoustically coupled to the casing.
E2. The method according to embodiment E1, wherein the expanded set cement has a Young's modulus from about 1 to about 10 GPa, as determined by ASTM C469.
E3. The method according to embodiment E1 or E2, wherein the amount of the expanding agent present in the cement slurry is suitable to produce from 0.5 percent to 2 percent expansion of the cement slurry upon hardening into the expanded set cement.
E4. The method according to any one of embodiments E1 through E3, wherein the amount of the expanding agent present in the cement slurry is suitable to produce an amount of expansion of the cement slurry upon hardening into the expanded set cement suitable to compress at least a portion of a material present on a surface of the casing between the expanded set cement and the casing such that the expanded set cement is acoustically coupled to the casing.
E5. The method according to any one of embodiments E1 through E4, further comprising circulating an oil-based fluid through the annulus to deposit the material on the surface of the casing, and optionally displacing a portion of the oil-based fluid from the annulus with a spacer stage pumped ahead of the slurry.
E6. The method according to any one of embodiments E1 through E5, wherein the amount of the expanding agent present in the cement slurry is suitable to produce an amount of expansion of the cement slurry upon hardening into the expanded set cement suitable to form the expanded set cement which is acoustically coupled to the casing and to at least a portion of the formation.
E7. The method according to any one of embodiments E1 through E6, wherein the expanding agent is present in the cement slurry from about 0.1 percent by weight of hydraulic cement to about 20 percent by weight of hydraulic cement.
E8. The method according to any one of embodiments E1 through E7, wherein the expanding agent comprises CaO, MgO, or a combination thereof.
E9. A system for cementing a subterranean well in an annulus between a casing disposed within a borehole and a formation having a material disposed on an outer surface of the casing, comprising: a cement slurry stage comprising a hydraulic cement, water, and an amount of an expanding agent suitable to produce from 0.1 percent to 3 percent expansion of the cement slurry upon hardening into an expanded set cement as determined according to API 10B-5; and a pumping system to place a stage of the slurry in the annulus.
E10. The system according to embodiment E9, wherein the expanded set cement has a Young's Modulus from about 1 to about 10 GPa, as determined by ASTM C469.
E11. The system according to embodiments E9 or E10, further comprising an oil-based fluid for circulation in the annulus to dispose the material on the outer surface of the casing, and optionally a spacer stage for circulation in the annulus between the oil-based fluid and the cement slurry stage.
E12. The system according to any one of embodiments E9 through E11, wherein the amount of the expanding agent present in the cement slurry is suitable to produce an amount of expansion of the cement slurry upon hardening into the expanded set cement suitable to compress at least a portion of the material disposed on the outer surface of the casing between the expanded set cement and the casing such that the expanded set cement is acoustically coupled to the casing.
E13. The system according to any one of embodiments E9 through E12, wherein the amount of the expanding agent present in the cement slurry is suitable to produce an amount of expansion of the cement slurry upon hardening into the expanded set cement suitable to form the expanded set cement which is acoustically coupled to the casing and to at least a portion of the formation.
E14. The system according to any one of embodiments E9 through E13, wherein the expanding agent comprises CaO, MgO, or a combination thereof, and is present in the cement slurry from about 0.1 percent by weight of hydraulic cement to about 20 percent by weight of hydraulic cement.

### EXAMPLES

As an example of the improvement brought by this cement slurry and its method of use, experiments were carried out in a comparative example in which a well cementing testing apparatus was filled with a comparative cement slurry, which did not include the expanding agent. An example according to the present disclosure was also prepared wherein a well cementing testing apparatus was filled with a cement slurry according to embodiments disclosed herein. In these experiments, the outer surface of the casing was first covered with a layer of oil-based mud to a thickness from about 40 to 50 um to simulate a contaminated casing according to conditions often found downhole. The contaminated casing was then placed in the test rig consisting of two concentric tubes, an outer tube representing the formation and the inner tube which was the contaminated casing. The space between the casing and the outer tube was filled with the appropriate cement, the bottom end of the test apparatus was sealed and the top of the test apparatus was covered with oil to prevent drying or evaporation from the slurry, to simulate the constrained environment found in actual wells. The cement was allowed to set in each test apparatus for 5 days. After the cement was set, acoustic logs were measured using an ultrasonic pulse-echo well tool.

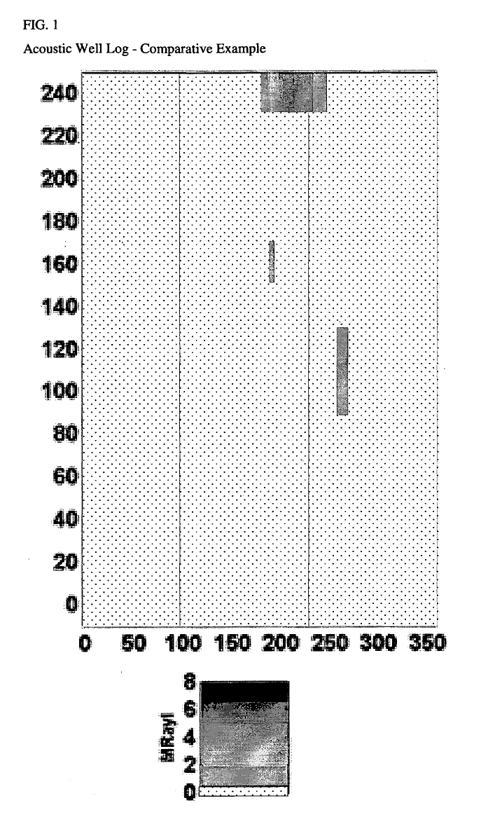

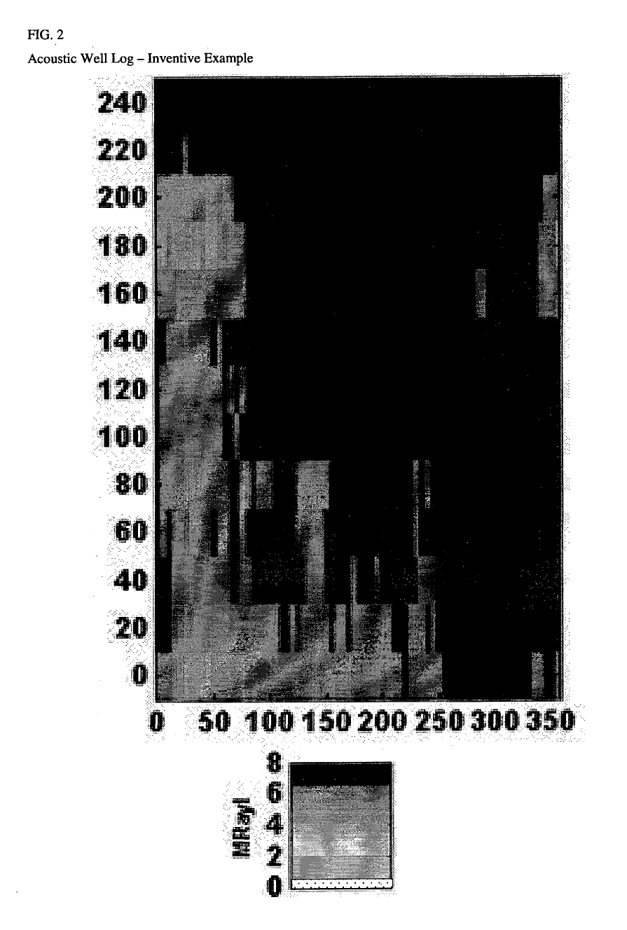

The acoustic well log of the comparative example is shown in FIG. 1 and the acoustic well log of the example according to embodiments of the present disclosure is shown in FIG. 2.

As these figures show, the comparative example with the non-expanding cement produced an acoustic log in which essentially none of the cement sheath was acoustically coupled to the casing. Inspection of the test rig showed the formation of a dry micro annulus (an air-gap), which is problematic.

In contrast, the acoustic log of the example shows excellent acoustic coupling and a correspondingly good cement sheath formed within. Inspection of the test rig showed the contamination compressed between the cement and the casing thus acoustically coupled there through.

Accordingly, the cement slurry and method disclosed herein significantly improves the acoustic coupling, even when the casing is contaminated with an oil-based fluid prior to cementing.

We claim:

1. A method of cementing a subterranean well having a casing disposed within a borehole, comprising:
(i) preparing a cement slurry comprising water, hydraulic cement, and an amount of an expanding agent suitable to produce from 0.1 percent to 3 percent expansion of the cement slurry upon hardening into an expanded set cement as determined according to API 10B-5;
(ii) disposing the slurry in an annulus between a formation and the casing in a downhole region of the well borehole; and
(iii) allowing the cement slurry to harden and expand in an amount sufficient to form an expanded set cement acoustically coupled to the casing.

2. The method of claim 1, wherein the expanded set cement has a Young's modulus from about 1 to about 10 GPa, as determined by ASTM C469.

3. The method of claim 1, wherein the amount of the expanding agent present in the cement slurry is suitable to produce from 0.5 percent to 2 percent expansion of the cement slurry upon hardening into the expanded set cement.

4. The method of claim 1, wherein the amount of the expanding agent present in the cement slurry is suitable to produce an amount of expansion of the cement slurry upon hardening into the expanded set cement suitable to compress at least a portion of a material present on a surface of the casing between the expanded set cement and the casing such that the expanded set cement is acoustically coupled to the casing.

5. The method of claim 4, further comprising circulating an oil-based fluid through the annulus to deposit the material on the surface of the casing, and displacing the oil-based fluid from the annulus with the cement slurry.

6. The method of claim 4, further comprising circulating an oil-based fluid through the annulus to deposit the material on the surface of the casing, and displacing a portion of the oil-based fluid from the annulus with a spacer stage pumped ahead of the cement slurry.

7. The method of claim 1, wherein the amount of the expanding agent present in the cement slurry is suitable to produce an amount of expansion of the cement slurry upon hardening into the expanded set cement suitable to form the expanded set cement which is acoustically coupled to the casing and to at least a portion of the formation.

8. The method of claim 1, wherein the expanding agent is present in the cement slurry from about 0.1 percent by weight of hydraulic cement to about 20 percent by weight of hydraulic cement.

9. The method of claim 1, wherein the expanding agent comprises CaO, MgO, or a combination thereof.

10. The method of claim 1, wherein the cement further comprises an accelerator, a retarder, an air entraining agent, a defoamer, a plasticizer, a pigment, a corrosion inhibitor, fly ash, ground granulated blast furnace slag, silica fume, high reactivity metakaolin, inorganic fibers, organic fibers, carbon nanofibers, or a combination thereof.

11. A system for cementing a subterranean well in an annulus between a casing disposed within a borehole and a formation, comprising: a cement slurry stage comprising a hydraulic cement, water, and an amount of an expanding agent suitable to produce from 0.1 percent to 3 percent expansion of the cement slurry upon hardening into an expanded set cement as determined according to API 10B-5; and a pumping system to place a stage of the slurry in the annulus.

12. The system of claim 11, wherein the expanded set cement has a Young's Modulus from about 1 to about 10 GPa, as determined by ASTM C469.

13. The system of claim 11, wherein the amount of the expanding agent present in the cement slurry is suitable to produce an amount of expansion of the cement slurry upon hardening into the expanded set cement that the expanded set cement is acoustically coupled to the casing.

14. The system of claim 13, wherein the amount of the expanding agent present in the cement slurry is suitable to produce an amount of expansion of the cement slurry upon hardening into the expanded set cement suitable to form the expanded set cement which is acoustically coupled to at least a portion of the formation.

15. The system of claim 13, further comprising a material deposited on a surface of the casing, and wherein at least a portion of a material present on a surface of the casing is compressed between the expanded set cement and the casing such that the expanded set cement is acoustically coupled to the casing.

16. The system of claim 15, further comprising an oil-based fluid for circulation in the annulus to deposit the material on the casing surface, and optionally a spacer stage for circulation in the annulus between the oil-based fluid and the cement slurry stage.

17. The system of claim 11, wherein the expanding agent is present in the cement slurry from about 0.1 percent by weight of hydraulic cement to about 20 percent by weight of hydraulic cement.

18. The system of claim 11, wherein the expanding agent comprises CaO, MgO, or a combination thereof.

19. The system of claim 11, wherein the cement further comprises an accelerator, a retarder, an air entraining agent, a defoamer, a plasticizer, a pigment, a corrosion inhibitor, fly ash, ground granulated blast furnace slag, silica fume, high reactivity metakaolin, inorganic fibers, organic fibers, carbon nanofibers, or a combination thereof.

20. A method of cementing a subterranean well having a material disposed on an outer surface of a casing disposed within a borehole, comprising:
(i) preparing a cement slurry comprising water, hydraulic cement, and an amount of an expanding agent suitable to produce expansion of the cement slurry upon hardening into an expanded set cement as determined according to API 10B-5;
(ii) disposing the slurry in an annulus between a formation and the outer surface of the casing in a downhole region of the well borehole; and
(iii) allowing the cement slurry to harden and expand in an amount sufficient to form an expanded set cement having a Young's modulus from about 1 to about 10 GPa, as determined by ASTM C469, which is acoustically coupled to the casing and to at least a portion of the formation;
the expanding agent comprising CaO, MgO, or a combination thereof; and
the amount of expanding agent present in the cement slurry being suitable to produce an amount of expansion of the cement slurry upon hardening into the expanded set cement which compresses at least a portion of a material present on the outer surface of the casing between the expanded set cement and the casing.
